(19) United States
(12) Patent Application Publication
(10) Pub. No.: US 2023/0243289 A1
(43) Pub. Date: Aug. 3, 2023

(54) METHOD FOR PROMOTING REGENERATION OF EXHAUST AFTERTREATMENT COMPONENTS OF INTERNAL COMBUSTION ENGINES

(71) Applicant: Perkins Engines Company Limited, Peterborough (GB)

(72) Inventor: Edward James SMITH, Rugeley (GB)

(73) Assignee: Perkins Engines Company Limited, Peterborough (GB)

(21) Appl. No.: 18/101,888

(22) Filed: Jan. 26, 2023

(30) Foreign Application Priority Data
Feb. 1, 2022 (GB) 2201269.4

(51) Int. Cl. F01P 7/06; F01P 7/04

(52) U.S. Cl. CPC F01P 7/06; F01P 7/048; F01P 2025/62

(57) ABSTRACT

A method for promoting regeneration of an exhaust aftertreatment component of an internal combustion engine includes: detecting a low load operating condition of the internal combustion engine; adjusting a pitch angle of one or more blades of a fan to reduce an air flow across a radiator in response to the detection of the low load operating condition; and increasing a rotational speed of the fan to increase a load on the internal combustion engine and to elevate temperature of an exhaust gas flowing across the exhaust aftertreatment component.

### TECHNICAL FIELD

The present disclosure relates to a method for promoting regeneration of an exhaust aftertreatment component of an internal combustion engine. More particularly, the present disclosure relates to controlling a radiator fan of the internal combustion engine to elevate temperature of an exhaust gas flowing across the exhaust aftertreatment component.

### BACKGROUND

Internal combustion engines, for example, used in electrical power generation systems, construction machines, etc., may be equipped with the exhaust aftertreatment components (e.g., a diesel oxidation catalyst, a diesel particulate filter, etc.). Such exhaust aftertreatment components may facilitate a reduction and/or removal of air pollutants, such as unburned hydrocarbons occurred due to poor or incomplete combustion, from exhaust gas released from the internal combustion engine. The working of such aftertreatment components may be dependent on the temperature of the exhaust gas. For example, when the internal combustion engine operates under a low-load operating condition (e.g., idle for a prolonged period, or at a low ambient temperature), the temperature of the exhaust gas may recede to a level at which regeneration of these exhaust aftertreatment components may fail to occur.

U.S. Pat. No. 7,322,183 discloses a method for controlling temperatures of exhaust gases emitted from an internal combustion engine. The method includes determining a desired increase in exhaust gas temperature relative to current exhaust gas temperatures. Further, the method includes operating a radiator fan as a function of the desired increase in exhaust gas temperature to increase load on the engine and thereby exhaust gas temperature to emit exhaust gases from the engine to meet the desired increase in exhaust gas temperature. Furthermore, the method includes continuously adjusting radiator fan operation to maintain the exhaust gas temperature at a regeneration exhaust gas temperature once the desired increase in exhaust gas temperature is achieved.

### SUMMARY OF THE INVENTION

In one aspect, the present disclosure is directed to a method for promoting regeneration of an exhaust aftertreatment component of an internal combustion engine. The method includes detecting, by a controller, a low load operating condition of the internal combustion engine. Further, the method includes adjusting, by the controller, a pitch angle of one or more blades of a fan to reduce an air flow across a radiator in response to the detection of the low load operating condition. Furthermore, the method includes increasing, by the controller, a rotational speed of the fan to increase a load on the internal combustion engine and to elevate temperature of an exhaust gas flowing across the exhaust aftertreatment component.

### BRIEF DESCRIPTION OF DRAWINGS

FIG. 1 illustrates an exemplary power system including an internal combustion engine having an exhaust aftertreatment component and a fan, in accordance with an embodiment of the present disclosure;

FIG. 2 illustrates the fan having one or more blades at a first pitch angle, in accordance with an embodiment of the present disclosure;

FIG. 3 illustrates the fan having the one or more blades at a second pitch angle, in accordance with an embodiment of the present disclosure; and

FIG. 4 depicts a flowchart illustrating a method for promoting regeneration of the exhaust aftertreatment component of the internal combustion engine, in accordance with an embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

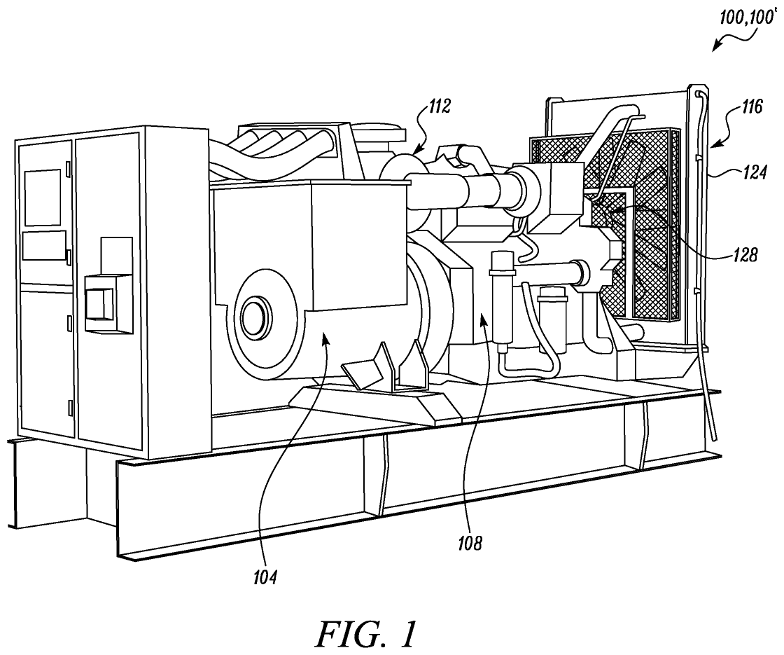

Referring to FIG. 1, an exemplary power system 100 is illustrated. The power system 100 may be utilized in stationary applications such as a generator set 100′. The generator set 100′ may be configured to provide on-site stand-by power or continuous electrical power at locations where a power supply from an electrical grid is limited or unavailable. The generator set 100′ may include a generator 104 and an internal combustion engine 108. The generator 104 may be configured to be driven by the internal combustion engine 108 to generate electrical power. The internal combustion engine 108 may be configured to power an operation of the generator 104, typically by combusting one or more fuels, such as diesel, gasoline natural gas, biodiesel, propane, etc. While combusting the one or more fuels, the internal combustion engine 108 may release exhaust gases containing unburned hydrocarbons, nitrogen oxide, carbon monoxide, etc. Further, in addition to the stationary application, the power system 100 may be utilized in mobile applications such as locomotives and marine engines.

The power system 100 includes an exhaust aftertreatment component 112, a radiator assembly 116, and a system 120 (discussed later). The exhaust aftertreatment component 112 may be configured to receive the exhaust gasses released from the internal combustion engine 108. The exhaust aftertreatment component 112 may be configured to condition or treat the exhaust gasses before they are discharged to the atmosphere. In an exemplary embodiment, the exhaust aftertreatment component 112 may include a diesel oxidation catalyst (hereinafter referred to as “DOC”) configured to oxidize the hydrocarbons and carbon monoxide of the exhaust gas into carbon dioxide and water.

In another exemplary embodiment, the exhaust aftertreatment component 112 may include a diesel particulate filter (hereinafter referred to as “DPF”) configured to trap and remove the unburned hydrocarbons (e.g., soot and/or ash) from the exhaust gas, as the exhaust gas flows across the diesel particulate filter. In yet another exemplary embodiment, the exhaust aftertreatment component 112 may include a selective catalytic reduction device (hereinafter referred to as “SCR”) configured to convert nitrogen oxides present in the exhaust gas into diatomic nitrogen and water. Such exemplary exhaust aftertreatment components 112, i.e., DOC, DPF, and SCR, and their functionality are known in the art, and therefore, they are not discussed, for the sake of brevity.

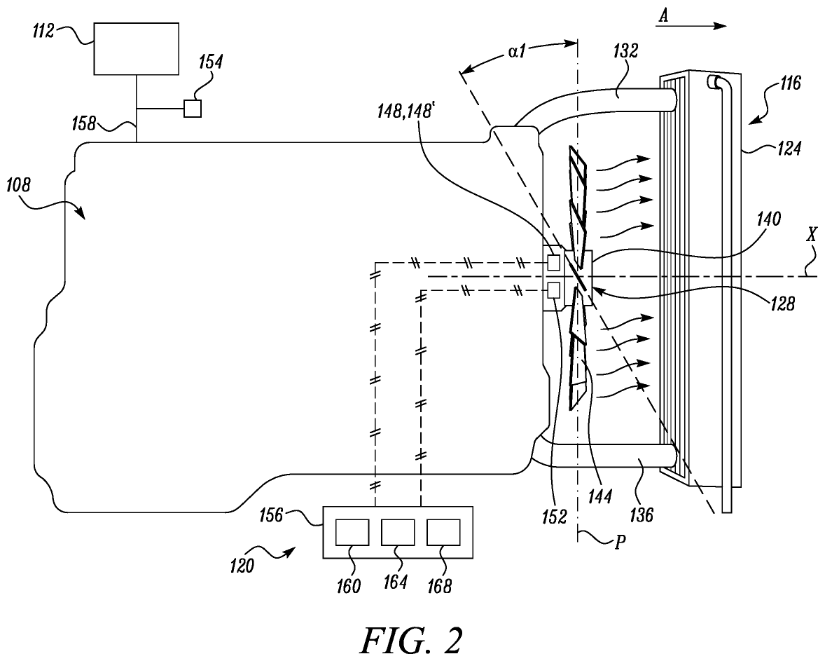

Referring to FIG. 2, the radiator assembly 116 is discussed. The radiator assembly 116 is configured to control a temperature of the internal combustion engine 108 and/or components therein through heat transfer. The radiator assembly 116 may include a radiator 124 and a fan 128. The radiator 124 may be connected to the internal combustion engine 108 via one or more conduits—a first conduit 132 and a second conduit 136. The radiator 124 may be a liquid-coolant-to-air cooler configured to cool the coolant circulating through the internal combustion engine 108 and the radiator 124.

For example, as the coolant circulates through the internal combustion engine 108, the coolant absorbs heat from the internal combustion engine 108 and further exits the internal combustion engine 108 as a heated coolant. The heated coolant is then transferred from the internal combustion engine 108 to the radiator 124, via the second conduit 136, and is allowed to circulate through the radiator 124 to transfer the heat to the atmosphere (e.g., to the airflow, produced by the fan 128, passing through the radiator 124) and exit the radiator 124 as a cooled coolant. The cooled coolant is then circulated back from the radiator 124 to the internal combustion engine 108, via the first conduit 132.

The fan 128 may be coupled to the internal combustion engine 108 to receive power from the internal combustion engine 108 to rotate. The fan 128 may include a hub portion 140 and one or more blades 144. The blades 144 may extend radially outwardly from the hub portion 140 and may be rotationally arrayed around the hub portion 140. The fan 128 may be configured to rotate about an axis ‘X’ and in a rotational plane ‘P’ to produce an air flow in a direction ‘A’ towards the radiator 124 to facilitate cooling of the coolant as the coolant circulates through the radiator 124. In some embodiments, the fan 128 may be operable to produce the air flow in a direction opposite to the direction ‘A’. The fan 128 may include a variable speed drive assembly 148 and a blade pitch regulator 152.

The variable speed drive assembly 148 may be configured to vary a rotational speed of the fan 128 with respect to a rotational speed of the internal combustion engine 108. The variable speed drive assembly 148 may include a geartrain 148′ (e.g., an epicyclic geartrain) positioned within the hub portion 140 of the fan 128. The geartrain 148′ may be configured to modify a gear ratio to cause the fan 128 and the internal combustion engine 108 to rotate at different rotational speeds. For example, the geartrain 148′ may modify the gear ratio to increase the rotational speed of the fan 128 with respect to the internal combustion engine 108 and/or may modify the gear ratio to decrease the rotational speed of the fan 128 with respect to the internal combustion engine 108.

In some embodiments, the variable speed drive assembly 148 may include a variable speed electric motor which may be driven by the electrical power from the generator 104 of the power system 100. In some embodiments, the variable speed drive assembly 148 may include a variable displacement hydraulic pump driven by the internal combustion engine 108. A variation to the type and position of the variable speed drive assembly 148 may be contemplated by someone in the art. Further, the variable speed drive assembly 148 may include any type of variable speed drive assembly or geartrain assembly now known or future developed.

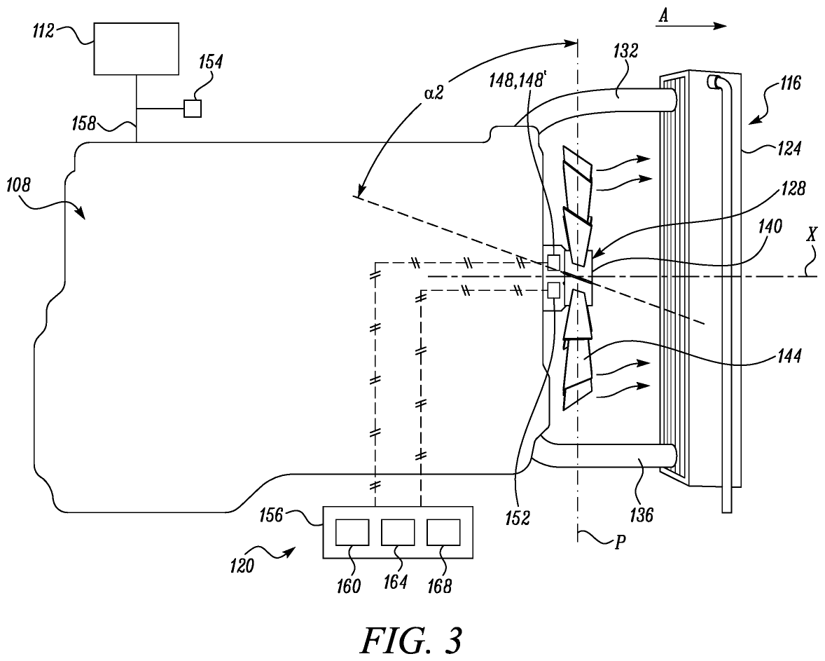

The blade pitch regulator 152 may be operatively coupled to the blades 144 of the fan 128. The blade pitch regulator 152 may be configured to actuate the blades 144 for modifying a pitch angle (i.e., an angle formed by each blade 144 with respect to the rotational plane ‘P’) of the blades 144. In an example, the blade pitch regulator 152 may modify the pitch angle of the blades 144 to a first pitch angle ‘α1’ (please see FIG. 2). The first pitch angle ‘α1’ may be 30 degrees with respect to the rotational plane ‘P’. In another example, the blade pitch regulator 152 may modify the pitch angle of the blades 144 to a second pitch angle ‘α2’ (please see FIG. 3). The second pitch angle ‘α2’ may be 70 degrees with respect to the rotational plane ‘P’. The values corresponding to the pitch angles ‘α1’ and ‘α2’, as noted above, are provided for illustrative purposes, and may include other values.

By actuating the blades 144 to different pitch angles, the blade pitch regulator 152 may enable the fan 128 to produce a variation in the amount of airflow at the same rotational speed of the fan 128. In an example, at 30 degrees pitch angle (as shown in FIG. 2) and at the rotational speed of 2300 rpm, the fan 128 may produce an airflow of 45,000 cubic meters per hour. In another example, at 70 degrees pitch angle (as shown in FIG. 3) and at the same rotational speed of 2300 rpm, the fan 128 may produce an airflow of 25,000 cubic meters per hour. The values corresponding to the airflow and rotational speed, as noted here, are provided for illustrative purposes, and may include other values.

In some embodiments, the blade pitch regulator 152 may include an electro-mechanical actuator and/or a hydraulic actuator to modify the pitch angles, arrangements, workings, and variations of which may be known and contemplated by someone in the art. Further, the blade pitch regulator 152 may include any other type of actuator now known or future developed.

The system 120 promotes regeneration of the exhaust aftertreatment component 112 of the internal combustion engine 108. The phrase “promotes regeneration” herein refers to enhancing or maintaining temperature conditions at the exhaust aftertreatment component 112 to ensure successful regeneration of the exhaust aftertreatment component 112. For example, the system 120 helps achieve an elevation in the temperature of the exhaust gas, flowing across the exhaust aftertreatment component 112, up to a level required for proper treatment and conditioning of the exhaust gas as well as for the regeneration of the exhaust aftertreatment component 112. The system 120 includes a controller 156—details of which will be discussed further below.

The controller 156 may be configured to receive one or more signals indicative of load conditions of the internal combustion engine 108. In an exemplary embodiment, the controller 156 may receive signals corresponding to temperatures of the exhaust gas, from an exhaust temperature sensor 154 (e.g., a thermocouple, an infrared sensor, etc., disposed at an exit 158 of the internal combustion engine 108 and upstream of the exhaust aftertreatment component 112).

On receipt of the signal corresponding to temperature of the exhaust gas, the controller 156 is configured to detect if the internal combustion engine 108 is operating under the low load operating condition. For example, if the controller 156 receives a signal indicating the temperature of the exhaust gas to be below a threshold temperature (e.g., stored in a memory 160 of the controller 156) for a predetermined period, the controller 156 may detect that the internal combustion engine 108 is operating under the low load operating condition.

In another exemplary embodiment, the controller 156 may receive signals corresponding to fuel injection rates, from an engine control unit (ECU) (not shown) associated with the internal combustion engine 108. If the controller 156 receives the signal indicating the fuel injection rate to be below a threshold fuel injection rate (e.g., stored in the memory 160 of the controller 156) for a predetermined period, the controller 156 may detect that the internal combustion engine 108 is operating under the low load operating condition.

In yet another exemplary embodiment, the controller 156 may receive signals corresponding to mass flow rates of intake air, from a mass airflow sensor disposed at an air intake manifold (not shown) of the internal combustion engine 108. If the controller 156 receives the signal indicating the mass flow rate of the intake air to be below a threshold mass flow rate (e.g., stored in the memory 160 of the controller 156) for a predetermined period, the controller 156 may detect that the internal combustion engine 108 is operating under the low load operating condition.

In yet another exemplary embodiment, the controller 156 may receive signals corresponding to throttle positions of the internal combustion engine 108, from an operator interface associated with the power system 100. If the controller 156 receives the signal corresponding to a low throttle level for a predetermined period, the controller 156 may detect that the internal combustion engine 108 is operating under the low load operating condition. In some embodiments, the controller 156 may utilize the signals corresponding to the temperatures of the exhaust gas along with the signals corresponding to at least one of the fuel injection rates, the mass flow rates of the intake air, and the throttle positions, to detect if the internal combustion engine 108 is operating under the low load operating condition.

Further, the controller 156 is configured to adjust the pitch angle of the blades 144 of the fan 128 in response to the load operating condition of the internal combustion engine 108. The controller 156 may adjust the pitch angle of the blades 144 to alter the amount of air flow across the radiator 124. In an example, on detection of the low load operating condition of the internal combustion engine 108, the controller 156 may command the blade pitch regulator 152 to actuate the blades 144 in a manner to attain the second pitch angle ‘α2’ (as shown in FIG. 3), and hence, reduce the amount of air flow across the radiator 124.

Also, the controller 156 is configured to vary the rotational speed of the fan 128. The controller 156 may operatively control the variable speed drive assembly 148 to vary the rotational speed of the fan 128. In an example, on detecting the low load operating condition of the internal combustion engine 108, the controller 156 may also operatively control (e.g., down-shift or up-shift) the variable speed drive assembly 148 to increase the rotational speed of the fan 128. In another example, in pursuance to the altering of the pitch angle of the blades 144, the controller 156 may operatively control the variable speed drive assembly 148 to increase the rotational speed of the fan 128.

The controller 156 may include a processor 164 to process the signal received from one or more sensors (e.g., exhaust temperature sensor, mass airflow sensor, etc.), engine control unit (ECU), and operator interface associated with the power system 100. Examples of the processor 164 may include, but are not limited to, an X86 processor, a Reduced Instruction Set Computing (RISC) processor, an Application Specific Integrated Circuit (ASIC) processor, a Complex Instruction Set Computing (CISC) processor, an Advanced RISC Machine (ARM) processor, or any other processor.

Further, the controller 156 may include a transceiver 168. According to various embodiments of the present disclosure, the transceiver 168 may enable the controller 156 to communicate (e.g., wirelessly) with the one or more sensors, the engine control unit (ECU), the operator interface, and the like, over one or more of wireless radio links, infrared communication links, short wavelength Ultra-high frequency radio waves, short-range high frequency waves, or the like. Example transceivers may include, but not limited to, wireless personal area network (WPAN) radios compliant with various IEEE 802.15 (Bluetooth™) standards, wireless local area network (WLAN) radios compliant with any of the various IEEE 802.11 (WiFi™) standards, wireless wide area network (WWAN) radios for cellular phone communication, wireless metropolitan area network (WMAN) radios compliant with various IEEE 802.15 (WiMAX™) standards, and wired local area network (LAN) Ethernet transceivers for network data communication.

Examples of the memory 160 may include a hard disk drive (HDD), and a secure digital (SD) card. Further, the memory 160 may include non-volatile/volatile memory units such as a random-access memory (RAM)/a read only memory (ROM), which may include associated input and output buses. The memory 160 may be configured to store various other instruction sets for various other functions of the power system 100, along with the set of instruction, discussed above.

### INDUSTRIAL APPLICABILITY

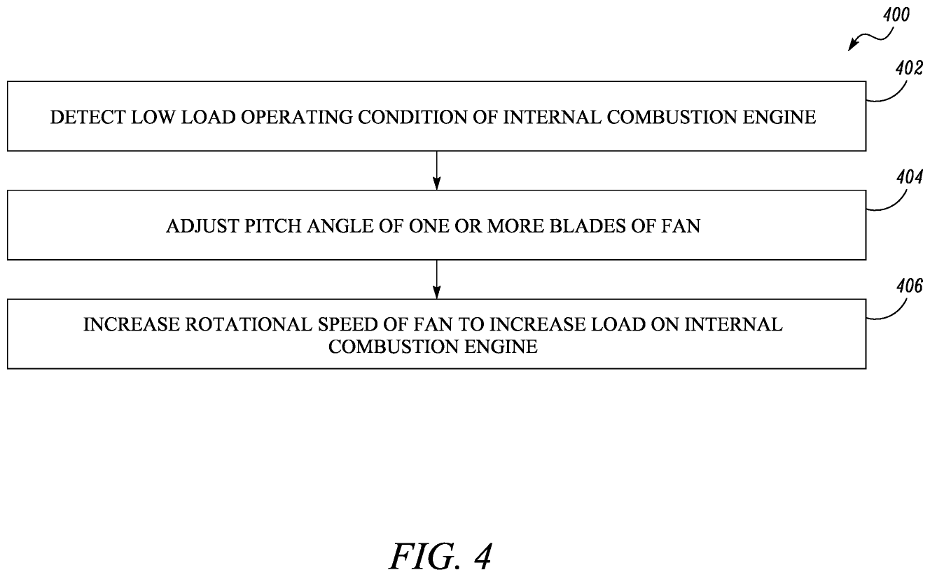

Referring to FIG. 4, an exemplary method 400 for promoting the regeneration of the exhaust aftertreatment component 112 is discussed. The method 400 is also discussed in conjunction with FIGS. 1-3. By viewing FIGS. 2 and 3 together, as discussed above, two different configurations of the fan 128 may be contemplated and visualized—a first configuration (or conventional configuration) at which the blades 144 of the fan 128 define the first pitch angle ‘α1’ with respect to the rotational plane ‘P’ (see FIG. 2) and a second configuration (or modified configuration) at which the blades 144 of the fan 128 define the second pitch angle ‘α2’ with respect to the rotational plane ‘P’ (see FIG. 3).

During the high or normal load operating conditions, the internal combustion engine 108 may release the exhaust gas having a temperature high enough to facilitate regeneration of the exhaust aftertreatment component 112. Also, at the high or normal load operating conditions, the fan 128 may be operated in the first configuration, i.e., the blades 144 of the fan 128 define the first pitch angle ‘α1’ (e.g., 30 degrees) with respect to the rotational plane ‘P’, and at a conventional speed to optimize the amount of airflow across the radiator 124 for effective cooling of the internal combustion engine 108 (please see FIG. 2).

However, when an internal combustion engine 108 operates under the low-load operating condition (e.g., for a predetermined period), the temperature of the exhaust gas (released from the internal combustion engine 108) may recede to a level at which the exhaust aftertreatment component 112 may fail to effectively condition or treat the exhaust gas before they are discharged to the atmosphere. This may result in an undesired accumulation of the unburned hydrocarbons within the exhaust aftertreatment component 112. In order to maintain the temperature of the exhaust gas to prevent such undesired accumulation of the unburned hydrocarbons and to promote regeneration of the exhaust aftertreatment component 112, the system 120 is provided.

At a step 402, the controller 156 detects the low load operating condition of the internal combustion engine 108. For that, the controller 156 may receive the signals indicative of the load conditions of the internal combustion engine 108. In an exemplary embodiment, the controller 156 may receive a signal corresponding to current temperature of the exhaust gas released from the internal combustion engine 108. The controller 156 may compare the current temperature of the exhaust gas with a threshold exhaust gas temperature (pre-stored in the memory 160) required for facilitating the regeneration of the exhaust aftertreatment component 112. Based on the comparison, the controller 156 may determine if the current temperature of the exhaust gas is below the threshold exhaust gas temperature. In case, if the current temperature of the exhaust gas is below the threshold exhaust gas temperature, the controller 156 may detect that the internal combustion engine 108 is operating in the low load operating condition.

In response to the detection of the low load operating condition of the internal combustion engine 108, the controller 156 adjusts the pitch angle of the blades 144 of the fan 128 (step 404). In an exemplary embodiment, the controller 156 may change the pitch angle of the blades 144 from the first pitch angle ‘α1’ to the second pitch angle ‘α2’ in response to the detection of the low load operating condition of the internal combustion engine 108. The controller 156 adjusts (e.g., increase) the pitch angle of the blades 144 to reduce the amount of the air flow across the radiator 124. For example, adjustment of the pitch angle of the blades 144 from the first pitch angle ‘α1’ to the second pitch angle ‘α2’ may cause aerodynamic stalling of the blades 144. Such aerodynamic stalling of the blades 144 may result in a reduction in the amount of airflow produced by the fan 128 (operating at the conventional speed) and an increment in the coolant temperature circulating across the radiator 124 and the internal combustion engine 108. In some embodiments, the controller 156 may decrease the pitch angle of the blades 144 from the first pitch angle ‘α1’ to reduce the amount of the air flow across the radiator 124 to cause the aerodynamic stalling of the blades 144.

At step 406, the controller 156 increases the rotational speed of the fan 128 to increase the load on the internal combustion engine 108 and to elevate the temperature of the exhaust gas flowing across the exhaust aftertreatment component 112. In an exemplary embodiment, the controller 156 may increase the rotational speed of the fan 128 from the conventional speed to a higher rotational speed, by controlling the variable speed drive assembly 148 (e.g., by controlling gear ratio of the geartrain 148′) operatively coupled to the fan 128. The increment in the rotational speed of the fan 128 as well as the aerodynamic stalling of the blades 144 may result in additional aerodynamic load on the fan 128 in turn causing an increment of the load (e.g., parasitic load) on the internal combustion engine 108. To meet the increased load demand on the internal combustion engine 108, the controller 156 may adjust one or more operating parameters (e.g., fuel injection rate) of the internal combustion engine 108 to elevate the temperature of the exhaust gas flowing across the exhaust aftertreatment component 112 so as to promote regeneration of the exhaust aftertreatment component 112.

The system 120 provides an efficient and cost-effective solution for promoting regeneration of the exhaust aftertreatment component 112 (e.g., associated with stationary machines such as the generator set 100′). The system 120 may perform the adjustment of the pitch angle of the blades 144 of the fan 128 as well as the increment in the rotational speed of the fan 128 to increase the load on the internal combustion engine 108, in response to the detection of the low load operating condition of the internal combustion engine 108. This may cause an increase in the temperature of the exhaust gas to a level high enough to facilitate regeneration of the exhaust aftertreatment component 112, and aid in prolonging the life of the exhaust aftertreatment component 112.

It will be apparent to those skilled in the art that various modifications and variations can be made to the disclosed assembly of the present disclosure without departing from the scope of the disclosure. Other embodiments will be apparent to those skilled in the art from consideration of the specification and practice of the method/process disclosed herein. It is intended that the specification and examples be considered as exemplary only, with a true scope of the disclosure being indicated by the following claims and their equivalent.

1. A method for promoting regeneration of an exhaust aftertreatment component of an internal combustion engine, the method comprising:
detecting, by a controller, a low load operating condition of the internal combustion engine;
adjusting, by the controller, a pitch angle of one or more blades of a fan to reduce an air flow across a radiator in response to the detection of the low load operating condition; and
increasing, by the controller, a rotational speed of the fan to increase a load on the internal combustion engine and to elevate temperature of an exhaust gas flowing across the exhaust aftertreatment component.
